(19) United States
(12) Patent Application Publication
(10) Pub. No.: US 2003/0177101 A1
(43) Pub. Date: Sep. 18, 2003

(54) Method of distributing electronic tokens to enable to consumer to pay for an item

(76) Inventor: Gavin Robert Ferris, London (GB)

Correspondence Address: Richard C Woodbridge, Woodbridge & Associates, PO Box 592, Princeton, NJ, 08542-0592, US

(21) Appl. No.: 10/343,264

(22) PCT Filed: Aug. 3, 2001
(86) PCT No.: PCT/GB01/03502

(30) Foreign Application Priority Data
Aug. 3, 2000 (GB) 0019012.4

(51) Int. Cl. G06F 17/60

(52) U.S. Cl. 705/65

(57) ABSTRACT

Electronic tokens are distributed without charge to a device (e.g. a digital radio) controlled by a consumer. The tokens are (a) distributed together with an enternainment media stream decoded by the device and (b) can be used by the consumer as payment for the item when sufficient token have been collected in the device but are not restricted to being redeemable only against that item.

### BACKGROUND TO THE INVENTION

1. Field of the Invention

This invention relates to a method of distributing electronic tokens to enable a consumer to pay for an item. The tokens are distributed as part of a media stream and constitute virtual currency; they are not specific to an item defined by the token supplier, unlike conventional coupons.

2. Description of the Prior Art

In a number of fields such as digital television and radio broadcasting, broadcasters desire to attract and retain consumers to their core media content streams, and also increasingly wish to diversify their businesses by selling additional products and services to those consumers (e.g., by providing data feeds, such as a ‘what's on’ entertainments listing, music for sale, software for sale etc.). However, the core challenge for such extended business models is the problem of how to extract an authenticated payment from the end user. Broadcast systems, particularly those using an air interface (e.g., Eureka 147 digital audio broadcasting DAB), do not by default have access to a back channel through which payment may be made. To address this problem, there have been three main approaches suggested in the prior art:

1. Modify the receiver so that it has access to a back channel for instance by integrating or connecting it to a cellular telephone or fixed line phone.

2. Use a smart card, which contains ‘credit units’, connected to the receiver.

3. Connect the receiver periodically to a device which ‘charges’ it with credit (where that device is ultimately authenticated either by being part of the vendor's approved core infrastructure, or otherwise by methods 1 or 2).

Unfortunately, for many systems (e.g., DAB-enabled MP3 players) no such approach may be practicable, since the receiver might conceivably only be used in a ‘stand alone’ fashion, and in any event, all of these solutions require either costly infrastructure, receiver modifications (card readers, modems), or both.

By contrast, the invention described here provides a mechanism that meets the needs of broadcasters described above, and which, although it can operate with additional benefits when one of the back-channel mechanisms 1-3 above is present, has no need of such provision for successful operation.

### SUMMARY OF THE INVENTION

In a first aspect of the invention, there is a method of distributing electronic tokens to enable a consumer to pay for an item, the method comprising the following steps:

(a) distributing without charge one or more electronic tokens to a device controlled by the consumer;

wherein the tokens are (a) distributed together with an entertainment media stream and (b) can be used by the consumer as payment for the item when sufficient tokens have been collected in the device but are not restricted to being redeemable only against that item.

Through this mechanism, the broadcaster can achieve both his aims. The user is encouraged to consume the primary content stream (in order to collect the tokens, which are subsequently of value to him), which promotes loyalty. And the broadcaster is subsequently able to offer digital payloads for sale, without the use of a back channel, by utilizing this credit that the user's media consumption has built up on his receiver for ‘payment’. The term ‘payment’ includes within its scope part-payment.

Such tokens are not specific to the particular item desired by the consumer and are hence quite unlike paper or electronic coupons. The tokens of the present invention are more akin to a virtual cutrency. Because they are not specific to any particular item, they do not form an overt part of the media stream—e.g. they are not superimposed on a visual scene, unlike some forms of virtual coupon. Further, because the tokens are distributed together with an entertainment media stream (e.g. radio, television etc.) which is received and played back by the device, they are unlike other forms of virtual currency, which are typically sent to a consumer or central server only after that consumer has completed an e-commerce transaction.

Additional aspects and details are described in the attached claims.

### DETAILED DESCRIPTION

An implementation of the invention is the ‘Broadcast Stream Loyalty Token System’, or BSLTS. It involves annotation of the target broadcast media stream which is entirely in the clear (i.e. is freely available and not encrypted) with a set of tokens, which are processed by the receiver when the main media channel is processed. These tokens, if validated by the receiver, are used to establish ‘credit’ on the user's receiver, which may then be used as ‘payment’ for an encrypted payload, which could (if desired) be sent by the same broadcast distribution system (e.g., an MOT data channel on a DAB receiver).

For maximum security, the token is used as a key to the decryption process for the payload. Note that it is not necessary for a payload to be sent after the token, since an encrypted package could be stored on a receiver in memory (or non-volatile store) in anticipation of future decryption. The value of tokens sent can accumulate, and tokens can either have nonspecific usage (so that they can be used to decrypt a wide range of payloads), or be restricted to a class of payload types or even to a specific payload. Similarly, payloads can be encrypted to be decodable by a particular value in denominations of a particular token, a particular value in denominations of a token applicable to a particular type or set of types, or a particular value in denominations of a general token. Tokens may have ‘time to live’ flags set which delete them, or ‘value decay’ (expressed as a function) which causes them to ‘waste’ over time. All tokens will have a unique serial code, and all token events (redemption, decay, conversion) will be logged. This logged data may be subsequently uploaded (subject to the normal privacy concerns) when a user eventually connects to part of the vendor infrastructure (for example, using a web browser), by which means the user's media consumption habits may be logged.

Depending on the system, users may be able to incur a certain amount of ‘debt’ in the denomination of the tokens. Furthermore, periodic ‘top ups’ may also automatically be generated. A variation of this latter point is the ‘perpetual token’ in which value contributed is some function of time—for example, a token may be set up that will provide a certain amount of credit every week for 3 weeks, and then expire.

Tokens can be specific to a particular location, if the receiver is capable of detecting this information. For example, in DAB single frequency networks using TII (transmitter identification information), it is generally possible for a receiver to locate its position within a few hundred meters, which would enable certain classes of location-specific tokens to be utilized).

In the most general case, a token is an executable component which may be run on a particular virtual machine, and which is fed all environment update events (such as time, location, receiver operation) by that machine environment. It would export a decoding interface for use by client applications.

Analysis and Advantages

For music purchase, for example, tokens could be associated with different IP content owners, such as major music copyright owners, or copyright licensing agencies. Then, a consumer could actively collect tokens associated with a given record label which might enable him to download a newly released album of an artist on that label or obtain performance tickets. Tokens distributed in this way could be strongly ‘branded’ and be broadcast in association with an advertisement from the related merchant, with the consumer having to press an on-screen icon (e.g. ‘activate token’) on hearing the advertisement. The value of the validated token could then be stored for future redemption.

Tokens broadcast in this way could be used to re-inforce advertising messages and coordinate with a store promotion.

Sending the Tokens

It is beneficial for the token stream to be a) lightweight with respect to, and b) closely connected to, the underlying media stream. So, for example, in DAB, the tokens would probably not be sent via the MOT data carousel protocol, since this would involve too much signaling relative to the message size, but would instead be transmitted as a custom data application. Furthermore, it is likely that they would either be sent in the X-PAD data of the audio frames, or steganograpically encoded (in the same way as watermarks) within the audio frame data itself. In a less compelling solution, an associated packet data service component would be used to hold the token.

Token Security and Logical Tokens

Note that token security may be improved by ensuring that the end media must be decoded for the token contained in the stream to become effective. For example, in Eureka-147 DAB, a token could require a checksum computed from a number of decoded (i.e., PCM digital) audio frames in order to operate. Due to the overhead of extracting and decoding multiple channels, this safeguard makes it much less likely that ‘rogue’ receivers will simply extract multiple tokens, to gain the benefit from them without requiring that the user be actually consuming the media stream. Another way to ensure this is to require that the user supply some unblocking code for the token, instructions for which would be transmitted in the corresponding media stream. For example, a music program on DAB could instruct users to ‘type in code 1234 now’ to authorize the token. For this to work, a human intelligence would have to be involved in the loop—an unmanned receiver would (in the general case) be unable to use the token, even if it were to be decoding the stream of which it was a part. Of course, it would involve additional user interface and interaction from the user.

Additional input from the receiver's virtual machine can help validate the token also, for example, whether or not the user has operated the teceiver controls within a certain period of time.

In the extreme case, some computed function of the received media may itself serve entirely as the token (decryption key), requiring no modification of the broadcast stream. For example, in DAB, a checksum created from the decoded PCM audio from a channel over a fixed number of frames (say, 20) could be utilized as the key to decode a particular payload (for example, a computer game that has been previously downloaded to be ‘given away’ in conjunction with the program). Although not necessarily the case, such ‘logical tokens’ tend to be better suited to being locked to particular payloads (as in the example above), since this requires minimum state within the decoder, the encryption for the payload in question simply being set to the appropriate value calculated in advance.

Note that one commercially important application of the BSLTS is in the purchase of downloaded music—as covered in patent application GB 0016695.9 to Radioscape Limited.

Tokens and the Back Channel

A primary virtue of the BSLTS described above is that it is not dependent upon a back channel to operate. However, the system is capable of operation in an extended mode when such connectivity is available (either directly or transitively, and either continuously or from time to time, as described in methods 1-3 above). For example, the loyalty points could be used to purchase goods at an e-commerce site (either affiliated with the broadcaster or otherwise). For our DAB example, a station might run an online CD store, where credit points could go either fill-way or part-way towards the cost of a CD (in much the same way as air miles are used in the prior art with respect to travel bookings). Of course, because of the token ID, a particular token can identify the track of interest in our example (if payload-specific tokens are utilized). And, of course, the user's ‘surfing’ habits across channels can (subject to the normal privacy issues) be sent back to the broadcaster either explicitly by the system, or implicitly in virtue of the ids of the stream of tokens redeemed (which identify moments in time and a particular media stream of application). The user could also be enabled to transform tokens into other denominations through the back channel (e.g., cash, air miles, points for a ‘pay as you go’ cellular phone etc.) through an appropriate arrangement.

Similarly, the credit a user maintains on a particular receiver could be augmented through either buying tokens via the back channel, or exchanging existing alternative forms of credit via the back channel (e.g., converting air miles, points for a ‘pay as you go’ cellular phone).

The broadcast side system should maintain a database of token ids against time and media stream. A hierarchical ‘token minting’ system may be used (much like the prior art of hierarchical certificates used to authenticate software downloads) to prevent rogue tokens being produced by theft of the token generation code from a broadcaster.

Tokens may of course be applied to media transmitted through either a bi-directional system (such as a direct-connect IP audio stream on the Internet) or via a bi-directional system used in broadcast mode (such as an IPv6 video broadcast on the Internet, or a cell broadcast within a cellular telephony system).

Token Shopping

In another embodiment, the user would be able to use their tokens in a physical shopping environment, much like a smart card. To continue out DAB example, once a user had built up sufficient ‘credit’ by listening to a particular station, he might then be able to go into a featured CD store on his high street, and connect his receiver to an EPS terminal to buy (or contribute towards the cost of a CD purchase. Note that this terminal need not be directly connected to the Internet in order to function.

1. Method of distributing electronic tokens to enable a consumer to pay for an item, the method comprising the following steps:
(a) distributing without charge one or more electronic tokens to a device controlled by the consumer;
wherein the tokens are (a) distributed together with an entertainment media stream and (b) can be used by the consumer as payment for the item when sufficient tokens have been collected in the device but are not restricted to being redeemable only against that item.

2. The method of claim 1 in which the item relates to the content of the media stream.

3. The method of claim 1 in which the electronic tokens are received at the device and which are validated to provide a credit value stored on the device.

4. The method of claim 3 in which the credit value is used to decrypt a payload sent over the same broadcast media stream as the electronic tokens.

5. The method of claim 1 in which the electronic tokens are distributed using one of the following systems: digital radio, digital television, direct-connect Internet, broadcast over the Internet, or cellular radio.

6. The method of claim 1 in which the electronic tokens are implicitly present as a function of an unmodified media stream.

7. The method of claim 1 in which the electronic tokens can be exchanged for cash, loyalty scheme points, pay-as-you-talk cellular phone units or any other kinds of units which can be redeemed for items.

8. The method of claim 1 in which the electronic tokens can be sold and/or purchased over a network.

9. The method of claim 1 in which the electronic tokens can be validated only by a consumer responding to a prompt issued from the device.

10. The method of claim 1 in which the electronic tokens stored at a device fully expire after a pre-set time.

11. The method of claim 1 in which the electronic tokens stored at a device decay over time.

12. The method of claim 1 in which the electronic tokens are steganographically hidden into a media stream.

13. The method of claim 1 in which the electronic tokens are executable components running on a virtual machine and which are fed events by the virtual machine and which perform decoding for client software.

14. The method of claim 1 in which the electronic tokens are specific to a particular parameter of the device.

15. The method of claim 14 in which the particular parameters include one or more of the following: location, user activity, time.

16. The method of claim 1 in which the electronic tokens are generated using a hierarchical token minting system.

17. The method of claim 1 in which the electronic tokens enable music in the media stream associated with the tokens to be lawfully copied or downloaded.

18. The method of claim 1 in which the electronic tokens are exchanged for items in a physical shop.

19. The method of claim 1 in which the nature of the use of electronic tokens by a consumer to acquire items is communicated to one or more merchants to enable them to track the acquisition patterns of that consumer.

20. The method of claim 1 in which the electronic tokens are attached to particular classes or instances of an item in a media stream.

21. The method of claim 1 in which the electronic token is needed to decrypt an item.

22. A method of using an electronic tokens to enable a consumer to pay for an item, the method comprising the following steps:
(a) receiving one or more electronic tokens at a device controlled by the consumer;
wherein the tokens are (a) distributed together with an entertainment media stream and (b) can be used by the consumer as payment for the item when sufficient tokens have been collected in the device but ate not restricted to being redeemable only against that item.

23. Apparatus for enabling a consumer to pay for an item, the apparatus being programmed to perform the method of claim 22.
